(19) United States
(12) Patent Application Publication
(10) Pub. No.: US 2008/0256434 A1
(43) Pub. Date: Oct. 16, 2008

(54) Methods, Systems, And Computer Program Products For Associating User-Provided Annotation Data With Markup Content Of A Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/733,553

(22) Filed: Apr. 10, 2007

(51) Int. Cl. G06F 17/21; G06F 17/00; G06F 15/173

(52) U.S. Cl. 715/230; 709/226; 715/234

(57) ABSTRACT

Methods and systems are described for associating user-provided annotation data with markup content of a resource. In one aspect, an annotation element is detected through processing a resource for presentation by a client. The annotation element is defined in a markup-language for accepting annotation and is associated with a tag defining a boundary of markup content for the resource. Based on the annotation element, a form for receiving user-provided annotation data is presented. The received annotation data is associated with the markup content bounded by the tag. In another aspect, a resource including the annotation element is provided. The provided resource including the annotation element is provided to a network entity, such as a client or a server.

### BACKGROUND

Annotation of resources, such as web pages, is currently done using a system independent of the resource and often independent of the resource provider. This makes the task of annotating resources difficult, given, for example, the fact that Web pages and Web site structure often changes. One approach is to provide a form in the resource to allow a user to effectively annotate the resource by filling out the form. These forms, if displayed in, for example a Web page, take up valuable screen space and in some cases are not consistent with the purpose and layout of the page. In another approach, the form for annotation input is instead provided as a pop-up or an overlay. In either case, a page developer must explicitly develop annotation forms for each element or portion of the page, thus generating a great deal of work if numerous portions of the page are to be “annotatable.” The result is that few Web pages provide the ability for a user to provide annotations, and for those few that do, only selected portions or elements of the page provide for annotation.

There is currently no facility built in to a markup language that provides a standard specification for enabling an element of a resource to be annotated. Such a facility would allow a browser or browser plug-in to provide the user interface for all annotatable elements or content portions of a resource, thus freeing the resource developer of the need to enable each element and minimizing the effects of resource provider (such as Web sites) structure changes and/or changes to the resource. Accordingly, there exists a need for methods, systems, and computer program products for associating user-provided annotation data with markup content of a resource.

### SUMMARY

Methods and systems are described for associating user-provided annotation data with markup content of a resource. In one aspect, an annotation element is detected through processing a resource for presentation by a client. The annotation element is defined in a markup-language for accepting annotation and that is associated with a tag defining a boundary of markup content for the resource. Based on the annotation element, a form for receiving user-provided annotation data is presented. The received annotation data is associated with the markup content bounded by the tag.

In another aspect, a resource including an annotation element is provided. The annotation element is defined in a markup-language for accepting annotation. The annotation element is associated with a form for receiving user-provided annotation data and is associated with a tag defining a boundary of markup content for the resource. The resource is provided to a network entity that is one of a client and a server for providing the resource to the client. The provided resource allows for the user-provided annotation data received via the associated form to be associated with the markup content bounded by the tag via the network entity.

In another aspect, a system for associating user-provided annotation data with markup content of a resource includes: means for detecting, through processing a resource for presentation by a client, an annotation element that is defined in a markup-language for accepting annotation and that is associated with a tag defining a boundary of markup content for the resource; means for presenting, based on the annotation element, a form for receiving user-provided annotation data; and means for associating the received annotation data with the markup content bounded by the tag.

In another aspect, a system for associating user-provided annotation data with markup content of a resource includes: a markup detector component configured for detecting, through processing a resource for presentation by a client, an annotation element that is defined in a markup-language for accepting annotation and that is associated with a tag defining a boundary of markup content for the resource; a presentation manager component configured for presenting, based on the annotation element, a form for receiving user-provided annotation data; and an annotation manager component configured for associating the received annotation data with the markup content bounded by the tag.

In another aspect, a system for associating user-provided annotation data with markup content of a resource includes: means for providing a resource including an annotation element that is defined in a markup-language for accepting annotation, wherein the annotation element is associated with a form for receiving user-provided annotation data and is associated with a tag defining a boundary of markup content for the resource; and means for providing the resource to a network entity, wherein the network entity is one of a client and a server for providing the resource to the client, the provided resource allowing for the user-provided annotation data received via the associated form to be associated with the markup content bounded by the tag via the network entity.

In another aspect, a system for associating user-provided annotation data with markup content of a resource includes: a resource manager component configured for: providing a resource including an annotation element that is defined in a markup-language for accepting annotation, wherein the annotation element is associated with a form for receiving user-provided annotation data and is associated with a tag defining a boundary of markup content for the resource; and providing the resource to a network entity, wherein the network entity is one of a client and a server for providing the resource to the client, the provided resource allowing for the user-provided annotation data received via the associated form to be associated with the markup content bounded by the tag via the network entity.

In another aspect, a computer readable medium includes a computer program, executable by a machine, for associating user-provided annotation data with markup content of a resource. The computer program includes executable instructions for: detecting, through processing a resource for presentation by a client, an annotation element that is defined in a markup-language for accepting annotation and that is associated with a tag defining a boundary of markup content for the resource; presenting, based on the annotation element, a form for receiving user-provided annotation data; and associating the received annotation data with the markup content bounded by the tag.

In another aspect, a computer readable medium includes a computer program, executable by a machine, for associating user-provided annotation data with markup content of a resource. The computer program includes executable instructions for: providing a resource including an annotation element that is defined in a markup-language for accepting annotation, wherein the annotation element is associated with a form for receiving user-provided annotation data and is associated with a tag defining a boundary of markup content for the resource; and providing the resource to a network entity, wherein the network entity is one of a client and a server for providing the resource to the client, the provided resource allowing for the user-provided annotation data received via the associated form to be associated with the markup content bounded by the tag via the network entity.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for associating user-provided annotation data with markup content of a resource according to an exemplary embodiment of the subject matter described herein;

FIGS. 2 and 3 are block diagrams illustrating systems for associating user-provided annotation data with markup content of a resource according to other exemplary embodiments of the subject matter described herein;

FIG. 4 is a message flow diagram illustrating messages exchanged by a client, server, and/or other network entities for associating user-provided annotation data with markup content of a resource according to another embodiment of the subject matter described herein;

FIG. 5 is a flow diagram illustrating a method for associating user-provided annotation data with markup content of a resource according to another exemplary embodiment of the subject matter described herein; and

FIGS. 6, 7, and 8 are block diagrams illustrating systems for associating user-provided annotation data with markup content of a resource according to other exemplary embodiments of the subject matter described herein.

### DETAILED DESCRIPTION

Portions of this description make reference to a declarative markup language or simply a markup language. Procedural programming requires that the programmer tell the computer what to do (i.e., how to produce an output given one or more inputs). A programmer is required to know or create a suitable algorithm. Using declarative programming, however, a developer uses the predefined relationships between the entities used and their purpose. That is, a developer knows, and must abide by the assigned structure and meaning of the markup elements because it is predefined. Declarative markup languages are thus inherently safer than procedural programming languages, since declarative languages have no direct control over a processor or system resources, as opposed to procedural languages. For example, receiving and displaying hypertext markup language (HTML) is a relatively safe operation when compared to receiving HTML including one or more scripts written in Javascript. Javascript is a procedural language and can be used for creating malicious software that threatens the security, privacy, and data integrity of resources on a device processing a malicious script. HTML poses little if any threat when used without a procedural language retrieved from a remote computer (e.g., without scripts).

A markup language establishes a vocabulary, grammar, and syntax of codes, referred to as “elements” in this document that provide extra information about the content of a resource. The extra information can include, for example, information about the structure of the resource, information about the presentation of the resource, and/or information that constitutes metadata associated with the resource. The codes or elements of a markup language are typically intermingled within the content of a resource. A markup language can provide elements applicable to text, image, video, or other forms of data included in and/or referenced by a resource using the markup language.

Perhaps the most widely known markup language is HTML, which exists in several versions and variants. Other well-known markup languages include standard generalized markup) language (SGML) from which HTML is derived, extensible markup language (XML), DocBook, mathematical markup language (MathML), scalable vector graphics (SVG), resource description framework (RDF), binary XML, wireless markup language (WML), synchronized multimedia integration language (SMIL), and many more.

A tag is a markup language label that is recognizable by a markup language processor as markup as opposed to resource content. For example, in XML, tags are indicated by the symbols, ‘<’ and ‘>’. Tags can be made up of an opening tag and closing tag as in: <p>content</p>, where the <p> tag indicates a paragraph and the </p> indicates the end of the paragraph and where <p> is the opening tag and </p> is the closing tag. Everything in between is considered to be content of the <p> tag. Tags can also be expressed as a single unit, such as: <br/>, which in HTML indicates that a line break should be inserted in the content at the location indicated by the <br/> tag.

A tag can have one or more attributes that modify the meaning or processing of the tag. For example, <p id=“0001” text=“content”/> is the same <p> tag as before with two attributes. The id attribute provides, through an assigned value, an identifier for the tag in which it is used. The identifier in this example is “0001” and should be unique for all tags used in the same resource. The text attribute provides an alternate mechanism for providing paragraph content. The value of the text attribute is the paragraph and is equivalent to <p>content</p>. Tags, attributes, values, and the syntactic symbols are all elements of the markup language.

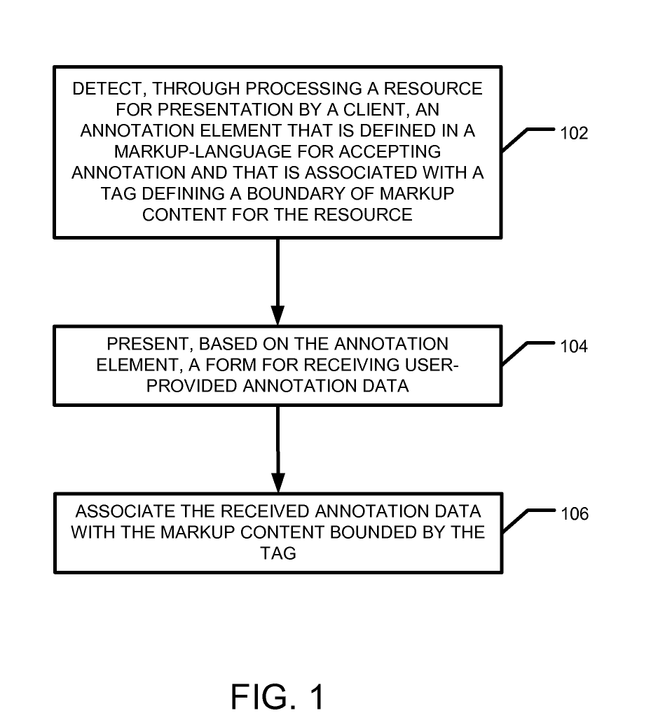

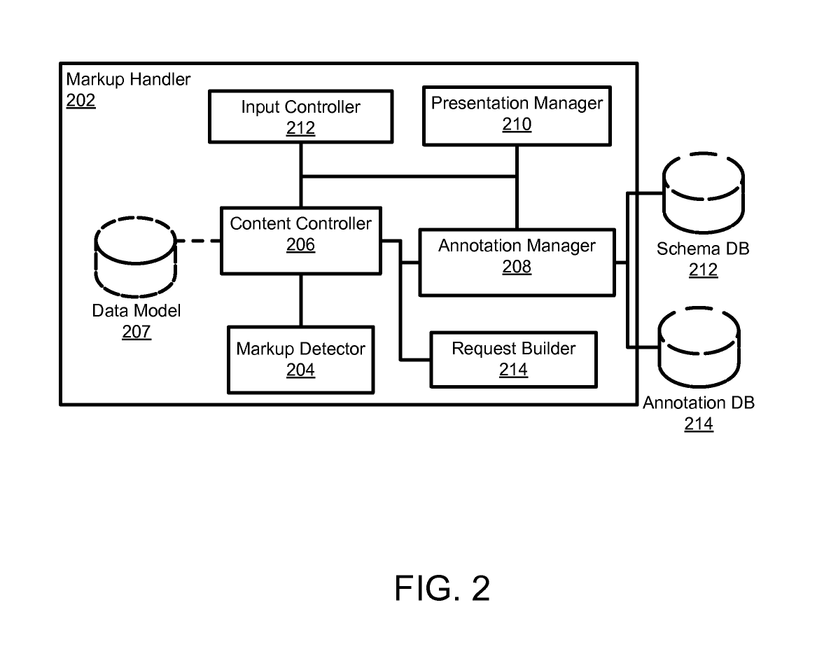

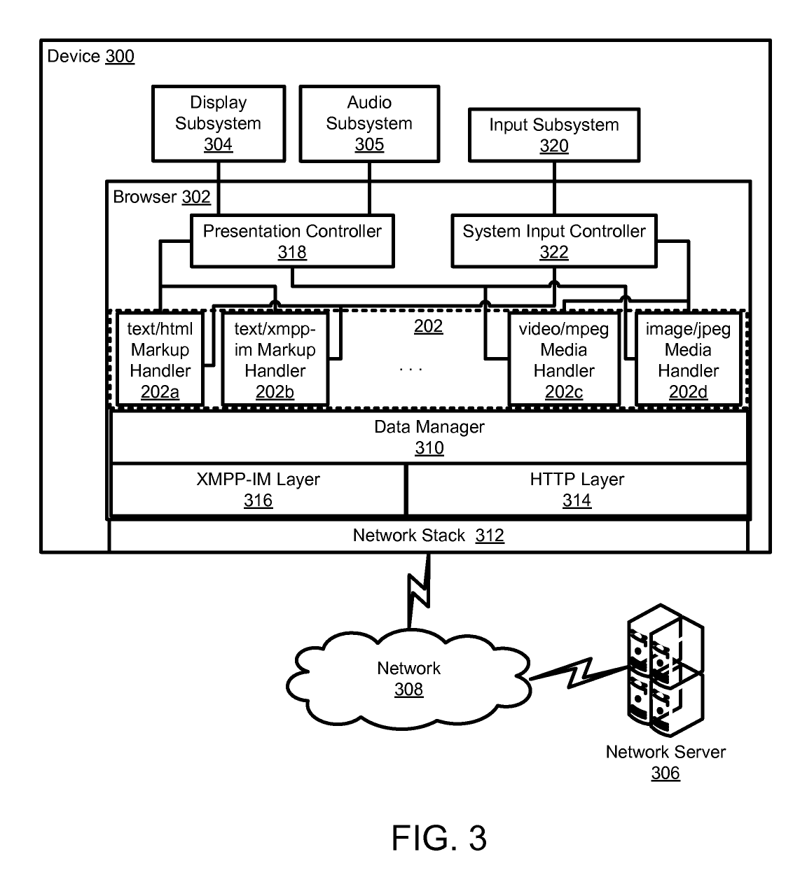

FIG. 1 is a flow diagram illustrating a method for associating user-provided annotation data with markup content of a resource according to an exemplary embodiment of the subject matter described herein. FIGS. 2 and 3 are block diagrams illustrating systems for associating user-provided annotation data with markup content of a resource according to other exemplary embodiments of the subject matter described herein. The method illustrated in FIG. 1 can be carried out by, for example, some or all of the components illustrated in the exemplary systems of FIGS. 2 and/or 3.

The exemplary systems of FIGS. 2 and 3 are described below in terms of web-based markup languages including variants of HTML and XML. It should, however, be understood that many markup languages exist for creating text-based content, as well as media-based content, including audio-, video-, and image-based content. In addition, a number of markup languages can be used together to specify a presentable resource. In addition to markup languages based on open standards, many proprietary markup languages are also currently in use, including for example ADOBE's FLASH. The exemplary systems of FIGS. 2 and 3 can be embodied such that they are configured to perform the method of FIG. 1 with respect to any markup-based language. Thus, any of these markup languages and appropriate variations of the systems for performing the methods described herein with respect to these markup languages is intended to be embraced by the subject matter described herein.

With reference to FIG. 1, in block 102, through processing a resource for presentation by a client, an annotation element is detected that is defined in a markup-language for accepting annotation and that is associated with a tag defining a boundary of markup content for the resource. Accordingly, a system for associating user-provided annotation data with markup content of a resource includes means for detecting, through processing a resource for presentation by a client, an annotation element that is defined in a markup-language for accepting annotation and that is associated with a tag defining a boundary of markup content for the resource. For example, as illustrated in FIG. 2, a markup detector component 204 can be configured for detecting, through processing a resource for presentation by a client, an annotation element that is defined in a markup-language for accepting annotation and that is associated with a tag defining a boundary of markup content for the resource.

In one aspect, the annotation element includes an annotation tag associated with the tag defining the boundary of the markup content for the resource. The annotation tag is defined in the markup-language for accepting annotation. For example, a tag element of an XML-based markup language, <annotate>, can be defined as an element for identifying a portion of content bounded by an associated markup language tag for which annotation data can be received and/or retrieved. In another aspect, the annotation element includes an attribute for the tag defining the boundary of the markup content for the resource. The attribute is defined in the markup-language for accepting annotation. For example, an attribute, “annotate”, can be included in any markup language tag indicating that the content of the tag including the “annotate” attribute is content for which annotation data can be received and/or retrieved. In yet another aspect, a specified value of an attribute can be defined by the markup language for receiving annotation. In a still further aspect, a syntactic symbol or structural relationship associated with an element can be defined by a markup language for receiving annotation. Examples 1a, 1b, and 1c below illustrate how an <annotate> tag and/or an “annotate” attribute can be associated with a markup language tag that bounds a portion of the content of a resource. In the examples, the “annotate” tag name and attribute name are chosen for convenience and can be defined as any other symbol compatible with the rules of the markup language in which it is defined.

By way of example, many of the examples herein use HTML and/or XML as the markup language and detecting an annotation element includes detecting the annotation element through processing a markup-language-based page for presentation in a browser. For example, the markup detector component 204 can be configured for detecting an annotation element through processing a markup-language-based page, such as a Web page, for presentation in a browser. The use of HTML and/or XML, and pages are merely illustrative and is thus not intended to be limiting.

### EXAMPLE 1a

```
<head>
      <annotate>
  <title>My first HTML document</TITLE>
      </annotate>
</head>
```

In example 1a, a portion of an HTML document is depicted including a <head> element and a <title> element as currently specified in the HTML specification. By placing start and end <annotate> tags around the <title> elements and its content, the <title> tag is associated with the annotation element for accepting annotation. The <title> tag bounds a portion of the resource, which in this case is the string: “My first HTML document.” Alternatively, the start and end <title> tag can be included in the bounded portion. In yet another alternative, the tag <annotate> is associated with itself and, thus, the start and end <annotate> tags mark the boundary of the content that can be associated with annotation. It should be pointed out that it is not necessary to have two tags, such as start and end, for bounding the content, but in some cases a single tag may suffice and the use of a single tag is contemplated within the subject matter disclosed.

### EXAMPLE 1b

<head>
<title annotate=”TRUE”>My first HTML document</TITLE>
</head>

Example 1b illustrates the use of an attribute of a tag as a markup element for enabling the association of annotation data with a bounded portion of a resource. One advantage of using an attribute is that it can be defined as a valid attribute for all tags in a markup language or a portion, as required by the use of the markup language. The keyword, “TRUE”, is merely exemplary and indicates whether the content bounded by the associated <title> tag can be associated with annotation data. An element defined as an attribute value can take on multiple values, where a value indicates some aspect of allowed annotation data, such as the location of a schema that annotation data must conform to for the particular resource or an annotation type. For example, an annotation attribute and/or an attribute value such as “keyword-value” can indicate that annotation data is to be restricted to keyword-value pairs. In another example, an annotation attribute and/or attribute value “comment” can indicate that annotation data is to be restricted to text strings.

### EXAMPLE 1c

<book>
<title annotate=”comment” content=”My first book”/>
</book>

Example 1c is provided to illustrate one manner in which a single tag associated with an annotation element can bound a portion of a resource to identify it as annotatable. In Example 1c, a portion of an exemplary XML document is shown with a <book> tag for including information about a book. A <title> tag is allowed within a <book> start and end tag pair for providing title information for a particular book. It should be appreciated that many other elements can be supported for providing additional information about a book, such as a tag for specifying an author. The <title> tag in the exemplary XML document allows a book title to be specified in an attribute of the tag, shown as the “content” attribute in Example 1c. The annotate=“comment” attribute indicates to a client that the title of the book can be associated with annotation data in the form of a comment.

In other aspects, detecting an annotation element includes detecting the annotation element through processing a streaming media resource including markup defined in the markup language. For example, the markup detector component 204 can be configured for detecting an annotation element through processing a streaming media resource including markup defined in the markup language. Streaming media resources can include, for example, audio, video, images, and/or other streamed content.

With reference to FIG. 2, an exemplary markup handler 202 is illustrated. FIG. 3 illustrates an exemplary application, browser 302, with one or more markup handlers 202 configured to process resources. A markup handler 202 is configured to receive content of one or more specified types, process the content, and detect markup elements. The processing typically includes presentation of the resource via a presentation subsystem interoperating with a presentation device such as a display subsystem 304 and/or an audio subsystem 305 via a presentation controller 318 of the browser 302, as illustrated in FIG. 3.

In the markup handlers 202, a resource is processed by a markup detector 204 of the markup handlers 202. The markup detector 204 can validate the resource type by ensuring that the resource format including markup language in the resource complies with a set of rules defined for the resource based on its type and/or other factors. Through processing a resource, the markup detector 204 detects the annotation element in the resource along with other markup language elements.

In FIG. 3, an exemplary environment for hosting and operating a markup handler component 202 is shown. A plurality of markup handler components 202a-d, referred to collectively as markup handler component(s) 202, including media handlers for media resources (including streaming media) that can include markup language based portions, are included in the browser 302 operating within an operating environment of a client device 300. The operating environment can be that of a desktop computer, a portable computer, a server, a mobile device such as a cell phone, personal digital assistant, and the like, or any networked device configured to host a web browser or other executable that includes a markup handler 202. Also shown in FIG. 3 is a network server 306 in communication with the client 300 via a network 308, such as a local area network, wide area network, personal area network, cellular network, wireless network, and the like.

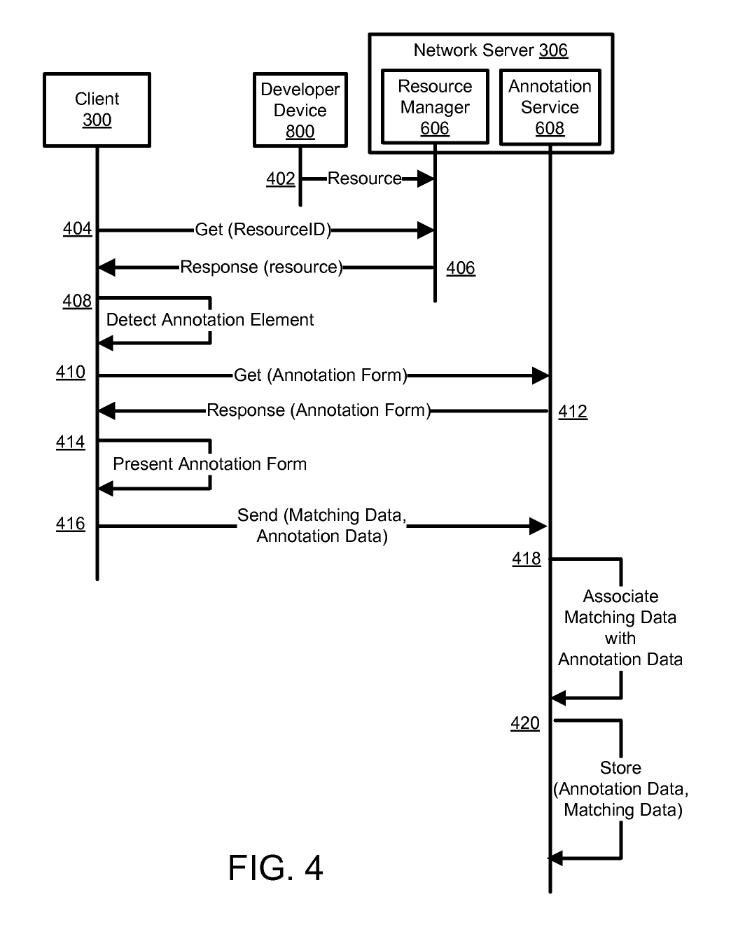

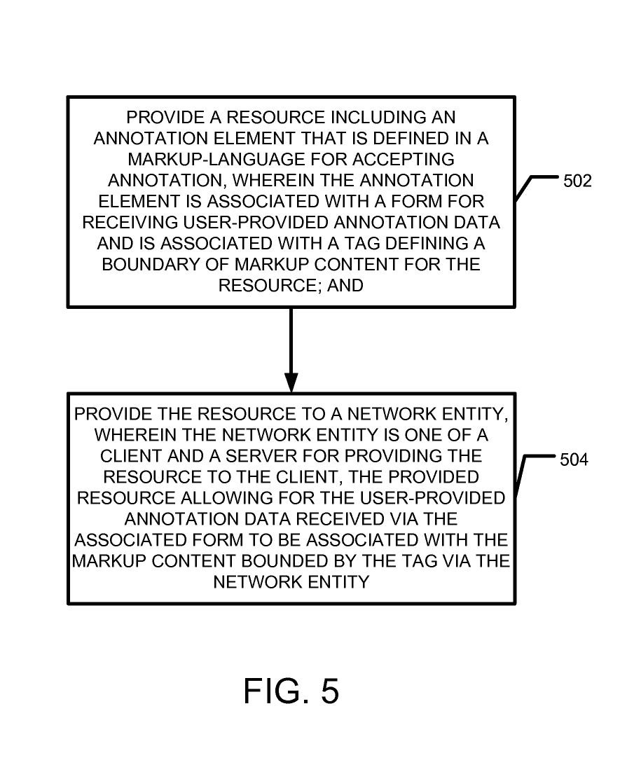

FIG. 4 is a message flow diagram illustrating messages exchanged by a client, server, and/or other network entities for associating user-provided annotation data with markup content of a resource according to another embodiment of the subject matter described herein. In FIG. 4, a message 404 sent by the client 300 is generated and sent by the browser 302 to the network server 306. Communications shown in FIG. 4 between the client 300 and a network server 306 are sent and received via the network 308. The network server 306 includes a resource manager component 606 and an annotation service component 608, which are discussed further below in connection with FIGS. 5-8. A response message 406 is received from the server 306 by a data manager 310 of the browser 302. The message 406 is received, for example, via a network interface card (NIC) (not shown), such as an Ethernet adapter included in the device 300. The NIC provides data packets to a network stack 312, such as a TCP/IP stack that processes packets received to detect and provide the message to the data manager 310. The processing of the messages in some embodiments includes processing by an application protocol layer, such as an HTTP layer 314 and/or an XMPP-IM layer 316, prior to reception by the data manager 310.

The data manager 310 determines a data type for data included in a resource. Resources can include data of multiple types. Based on the data type of a resource or a data type of a portion of a resource, the determined data type is used to determine a markup handler component 202 to process data of the determined data type. In the exemplary system illustrated in FIG. 3, multiple markup handlers 202 are shown, including a text/html markup handler component 202a for receiving and processing HTML markup language based resource data, a text/xmpp-im markup handler component 202b for receiving and processing xmpp-im markup language based resources, a video/mpeg media handler 202c for receiving and processing video streams using an motion picture experts group (MPEG) format including, for example, MPEG4 that supports markup language based streams, and an image/jpeg media handler 202d for receiving and processing image data in the joint photographic experts group (JPEG) format. JPEG data is typically received in an exchangeable image format (EXIF) file that supports a format that allows metadata, including markup-language-based metadata, to be included. The markup element detected in a media handler can be processed by the detecting media handler. Accordingly, a media handler 202c, 202d can also perform the markup-related functions of a markup handler component 202a, 202b for the purposes of this description. Alternatively, or in addition, markup elements received by a media handler 202c, 202d can be returned to the data manager 310 for routing to a markup handler component 202a, 202b. The markup handler components 202 shown in FIG. 3 are exemplary. Other markup, media, and/or data handlers are currently known to those skilled in the art and may be employed in addition to or instead of those shown in FIG. 3. Thus, through the type detection of the data manager 310 and the type(s) associated with each markup handler component 202, markup-language-based data of a resource can be received by a markup handler component 202 compatible with the markup language of the received data of the resource.

In FIG. 2, a content controller 206 includes instructions for processing markup elements as defined by the particular markup language, including annotation elements. In some markup handler components 202, the content controller 206 constructs a data model 207 of the received resource data. For example, for an XML-based resource, the content controller 206 typically builds a data model 207, known as a document object model (DOM), for allowing the content controller 206 to manipulate the data model 207 and locate specific markup elements and content based on a structure of the resource defined by the markup. When an annotation element is detected by the markup detector 204, the markup detector 204 and content controller 206 can use the rules of the markup language structure and syntax to locate an associated tag, as, for example, described with reference to Examples 1a-1c. The markup detector 204 and content controller 206 can determine one or more boundaries of a portion of the resource identified by the associated tag, as, for example, described with reference to Examples 1a-1c.

Example 2 below illustrates an HTML-based resource including, as an exemplary HTML element, a tag “<annotate>”. The “<annotate>” tag specifies that it and its content can be associated with annotation data by an application processing the resource including the <annotate> tag, such as the browser 302 and/or a plug-in of the browser 302.

### EXAMPLE 2

```
<!doctype HTML PUBLIC “-//W3C//DTD HTML 4.01//EN”
  “http://www.w3.org/TR/htmlX/strict.dtd”>
<html>
  <head>
    <title>My first HTML document</TITLE>
  </head>
  <annotate>
  <body>
    <p>Hello world!</p>
  </body>
  </annotate>
</html>
```

The HTML-based resource of Example 2 may be received at the browser 302 in a message, such as the message 406 of FIG. 4, and processed by the markup detector 204 of the text/html markup handler 202a. Detected elements are passed to the content controller 206 for validating. The content controller 206 also determines the structure of the resource, including relationships among markup elements. As illustrated by message 408 in FIG. 4, the markup detector 204 detects the annotation element, the <annotate> begin and end tags, and detects the association between the annotation element and the <body> begin and end tags based on the nested structure of the HTML resource. The message 408 can represent one or more subroutine calls initiated in the browser 302.

Subsequent to or during the processing of the resource data by the markup detector 204 and the content controller 206 of the markup handler component 202a, the content controller 206 provides instructions and a representation of the resource to a presentation manager component 210 of the markup handler component 202. The presentation manager component 210 provides the representation to an application including the markup handler component 202a, which in the current example is the browser 302. More specifically, the presentation manager component 210 of the markup handler component 202a provides a representation of the resource to a presentation controller 318 of the browser 302. The presentation controller 318 coordinates presentation of resource data from one or more handlers 202. For example, an HTML based resource can include a reference to an image, a video stream, and/or an audio stream. The presentation controller 318 directs the output of the corresponding handlers 202 to present a unified presentation.

Viewable resource representations are presented, for example, on a display (not shown) operatively coupled to a graphics adapter (not shown) included in the device 300. The presentation controller 318 interoperates with a display subsystem 304 of the operating environment of the device 300 to drive the graphics adapter and, as a result, cause the display of a visual representation of a resource. Audible resources are processed similarly using a speaker system, an audio driver, and an audio subsystem 305, for example.

Returning to FIG. 1, in block 104 a form for receiving user-provided annotation data is presented based on the annotation element. Accordingly, a system for associating user-provided annotation data with markup content of a resource includes means for presenting, based on the annotation element, a form for receiving user-provided annotation data. For example, as illustrated in FIG. 2, the presentation manager component 210 is configured for presenting, based on the annotation element, a form for receiving user-provided annotation data.

Example 1, as discussed above, illustrates the use of an “<annotate>” tag containing and HTML “<body>” tag and its contents indicating to the markup handler component 202a that the “<annotate>” tag and its contents can be associated with annotation data. In Example 2, the annotation element may or may not have a presentable effect when the resource is presented. A first input associated with presented content corresponding to the bounds established by the <body> start and end tags is received via an input device, such as mouse and/or keyboard, and provided to an input subsystem 320 and associated hardware of the device 300. The input signal is provided to a system input controller 322 of the browser 302. The system input controller 322 directs input signals to appropriate components in the browser 302 for handling.

With reference to both Example 2 and FIG. 2, the first input associated with the portion of the resource bounded by the body tag is provided to the text/html markup handler component 202a, where it is received by an input controller 212. The input controller 212 is configured to route the first input to an appropriate component for processing.

Annotation data can be managed by the client device 300, by the network server 306, by a resource provider or content distributor (not shown), or by some combination of these entities. Those skilled in the art will appreciate that many variations for managing annotation data are derivable. In one aspect, an annotation manager component 208 is provided at the client device 300 by, for example, an application, such as the browser 302, a plug-in of the browser 302, and/or another application operating on the device 300. In another aspect, an annotation service is provided by a provider of the resource, such as the annotation service component 608 of the network server 306. In another aspect, an annotation service can instead be provided by a third party (not shown). That is, neither the device 300 nor the network server 306 provides the annotation service, but instead the third party annotation service can be designated by, for example, the initial provider of the resource, the application using the resource, or both, and can be selected based on a rule. For example, a rule can require that a resource-provider-specified service is used unless a service has been specified by the client. The inverse of this rule can be used instead. One skilled in the art can derive any number of rules based on the subject matter described herein. The third-party annotation service specification can be user-provided. In addition, the client device 300 and/or the network server 306 can be configured to determine an annotation manager component 208 to use based on a characteristic of a resource, a characteristic of a provider, a characteristic of a using application, and/or a characteristic of a user of the application processing the markup language based resource.

In FIG. 2, the request is forwarded to an annotation manager component 208 for processing. In one aspect, presenting a form for receiving user-provided annotation data in block 104 includes presenting a form generated by the client device 300. For example, the presentation manager component 210 can be configured for presenting a form generated by the client device 300 for receiving user-provided annotation data. The browser 302 determines the format and rules to which the annotation data must conform. In one example, an annotation manager component 208 of the browser 302 uses a browser-provided user interface including a form. The annotation manager component 208 invokes the presentation manager component 210 to present the form as described above.

In another aspect, presenting a form for receiving user-provided annotation data in block 104 includes presenting a form received by the client device 300 from a remote network entity. For example, the presentation manager component 210 can be configured for presenting a form received by the client device 300 from a remote network entity, such as the network server 306 or a third party (not shown), for receiving user-provided annotation data. The annotation data can be managed by the third party or the network server 306. The input controller 212 provides the input to a request builder 214 either directly or via the content controller 206. The request builder generates a request based on the first input and sends the request via the network 308 to the annotation service component 608 in the network server 306. The annotation service component 608 determines the format and rules to which the annotation data must conform. In one example, the annotation service component 608 generates a user interface, such as an HTML-based page including a form and returns it to the browser 302 for presentation as illustrated by messages 410 and 412 in FIG. 4.

In another aspect, presenting a form for receiving user-provided annotation data in block 104 includes presenting a form configured for receiving the user-provided annotation data according to a schema that defines formatting and a rule for the user-provided annotation data. Schemas may be as complex or as simple as the supported schema languages allow. Example schema languages that may be used include document type definition (DTD), XML Schema, and resource description framework (RDF). For example, the presentation manager component 210 can be configured for presenting a form configured for receiving the user-provided annotation data according to a schema. The format and rules of the schema can be fixed. For example, the schema can be the same regardless of the provider of the resource, the schema can be the same for all resources provided by a resource provider regardless of the client, and/or the schema can be the same regardless of the resource provider and the client. The schema can be determined by the annotation manager component 210 and/or the annotation service 608, depending on the origin of the form being provided. The schema can also be user-editable.

In another aspect, presenting a form for receiving user-provided annotation data in block 104 includes presenting a keyword and allowing for a user to provide a value for the presented keyword. For example, the presentation manager component 210 can be configured for presenting a form that presents a keyword and the form can allow for a user to provide a value for the presented keyword.

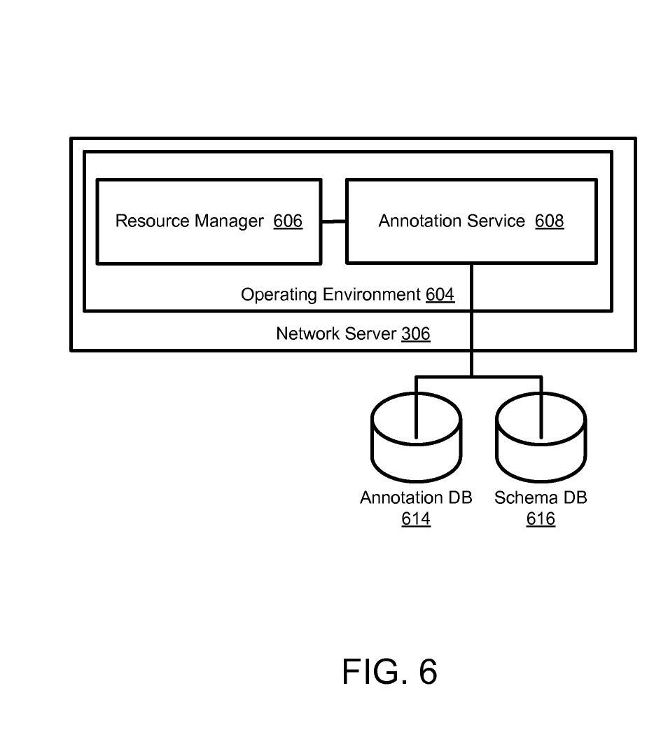

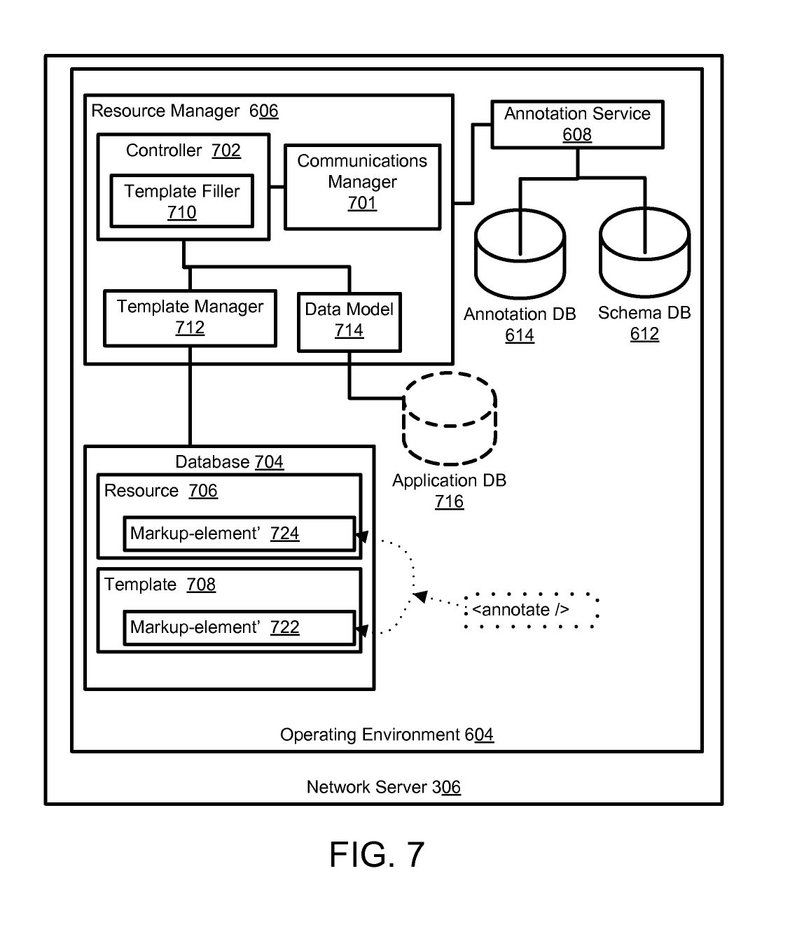

The schema associated with annotation data can be stored in a schema data base 212 shown in FIG. 2 hosted in the client device and/or in a schema data base 612 shown in FIGS. 6 and 7 hosted by the resource provider and/or hosted by a third party provider (not shown). The schema database 212 can include a plurality of schemas, some provided by the hosting device, some user-provided, and/or some provided from a remote source, such as an administration server.

Schemas can be associated with annotation data in a number of ways. In one aspect, presenting a form for receiving user-provided annotation data in block 104 includes presenting a form configured for receiving the user-provided annotation data according to a schema selected based on at least one of a provider of the resource, a type of the resource, the annotation element, the markup content bounded by the tag, other content in the resource, a task being performed via the resource, a user profile, and a time-based value. For example, the presentation manager component 210 can be configured for presenting a form configured for receiving the user-provided annotation data according to a schema selected based on at least one of a provider of the resource, a type of the resource, the annotation element, the markup content bounded by the tag, other content in the resource, a task being performed via the resource, a user profile, and a time-based value. It should be appreciated that the mechanisms listed for choosing an annotation schema is not an exhaustive list and that one skilled in the art can use many methods for choosing a schema, where all such methods are intended to be provided for by the subject matter disclosed herein.

The schema can be associated with a pre-generated form for receiving annotation data and/or the schema itself can be used to generate a form. For example, if a schema is specified in an XML language, a transform mechanism such as extensible stylesheet language (XSL) and/or extensible stylesheet language transformation (XSLT) can be used to generate an HTML resource for presenting a form for receiving annotation data.

In addition to storing a schema, additional rules can be associated with a schema, a resource provider, a user, a content type, or anything affecting the choice of a schema. For example, access control policies can control who can provide annotation data, what resources or portions thereof a user can provide data for, and what data a user can provide.

Additionally, a schema or associated policy can provide a cardinality rule for the relationship between a resource and annotation data. For example, an annotatable portion of a resource can be allowed to have only one set of annotation data based on an associated schema. That is, the cardinality between the resource and associated annotation data is one-to-one. In another example, an annotatable portion of a resource can be allowed to have an unlimited number of sets of annotation data based on an associated schema. The cardinality between the resource and annotation data is said to be one-to-many. For example, if a set of annotation data identifies owner information, the set of owner information can be associated with many resources or portions of resources. Further, many-to-many cardinality rules can be employed and enforced. For example, a resource can be annotated with a folksonomic tag. Many resources can be annotated with the same tag and resources can be annotated with a plurality of tags.

The messaging of the form handling process is illustrated in FIG. 4. A message 410 is for retrieving the form, a message 412 is for receiving the form information, and a message 414 is for presenting the form.

Additional examples of resources including annotation elements are provided below. Example 3 below illustrates an HTML-based resource including, as an exemplary HTML annotation element, an attribute associated with the <body> tag. An attribute “schema” is used to indicate by the resource provider a schema to use for any annotation data associated with the portion of the resource bounded by the <body> start and end tags.

### EXAMPLE 3

```
<!doctype HTML PUBLIC “-//W3C//DTD HTML 4.01//EN”
  “http://www.w3.org/TR/htmlX/strict.dtd”>
<html>
  <head>
    <title>My first HTML document</TITLE>
  </head>
  <body annotate=”TRUE”
schema=”http://my.schemas.com/bodyNotes.xml”>
    <p>Hello world!</p>
  </body>
</html>
```

Example 4 below illustrates an HTML-based resource including, as an exemplary HTML element, a “src” attribute. The “src” attribute is used to indicate an annotation manager component 208 and/or an annotation database 214 of a client 300, an annotation service component 608 and/or an annotation database 614 of the network server 306, depending on the functional split between the client, the resource provider, and a third-party service, as discussed above.

### EXAMPLE 4

```
<!doctype HTML PUBLIC “-//W3C//DTD HTML 4.01//EN”
  “http://www.w3.org/TR/htmlX/strict.dtd”>
<html>
  <head>
    <title>My first HTML document</TITLE>
  </head>
  <annotate schema=”http://my.schemas.com/bodyNotes.xml”
            src=”http://annotations.com”>
  <body>
    <p>Hello world!</p>
  </body>
  </annotate>
</html>
```

Example 5 below illustrates an HTML-based resource including, as an exemplary HTML element, a second element, <ansegment>, that can be used to define default attribute values for all annotatable entities within its scope. Its scope in the example is everything between the start and end <ansegment> tags. An “ansegement” attribute can also be supported that has the same meaning as the tag version, as can a specified value of an attribute. In the example, only the price portions can have annotation data associated with them.

### EXAMPLE 5

```
<ansegment source=”http://randomsource.unreal.net”>
<table border=“1”
    summary=“This table prices of fruit in our store.”>
<CAPTION><EM>Current Fruit Prices</EM></CAPTION>
<TR><TH>Fruit</TH><TH>Price</TH></TR>
<TR><TD>Apples</TD><annotate><TD>$0.99 per
    lb</TD></annotate></TR>
<TR><TD>Oranges</TD><annotate><TD>3 for
    $2</TD></annotate></TR>
<TR><TD>Bananas</TD><annotate><TD>$0.49 per
    lb</TD></annotate></TR>
<annotate path=”/exotic>
<TR><TD>Star Fruit</TD><annotate><TD>$2
    each</TD></annotate></TR>
</table>
</ansegment>
```

Example 6 below illustrates an HTML-based resource including, as an exemplary HTML element, a “Summary” attribute for allowing the resource provider to provide an annotation for the entire annotation segment. A user may optionally be able to change the summary as an annotation element or add an additional summary. The example illustrates that default annotations can be provided.

### EXAMPLE 6

```
<TABLE border=“1”
  summary=“This table prices of fruit in our store.”
      ansegment=”TRUE” source=”http://randomsource.unreal.net”>
<CAPTION><EM>Current Fruit Prices</EM></CAPTION>
<TR><TH>Fruit</TH><TH>Price</TH></TR>
<TR><TD>Apples</TD><annotate><TD>$0.99 per
      lb</TD></annotate></TR>
<TR><TD>Oranges</TD><annotate><TD>3 for
      $2</TD></annotate></TR>
<TR><TD>Bananas</TD><annotate><TD>$0.49 per
      lb</TD></annotate></TR>
<annotate path=”/exotic>
<TR><TD>Star Fruit</TD><annotate><TD>$2
      each</TD></annotate></TR>
</TABLE>
```

Returning to FIG. 1, in block 106 the received annotation data is associated with the markup content bounded by the tag. Accordingly, a system for associating user-provided annotation data with markup content of a resource includes means for associating the received annotation data with the markup content bounded by the tag. For example, as illustrated in FIG. 2, an annotation manager component 208 is configured for associating the received annotation data with the markup content bounded by the tag.

The associating of the received annotation data with the markup content bounded by the tag in block 106 can be performed by one or more of the client device 300 (as discussed here) or a network entity (as discussed further below), such as the network server 306 or a third party service. The associating of the received annotation data with the markup content bounded by the tag in block 106 can include storing the association of the received annotation data with the markup content at one of the client 300, a provider of the resource, such as the network server 306, and another network entity, such as a third party. In the example illustrated in FIG. 2, the annotation manager component 208 is configured for associating the received annotation data with the markup content bounded by the tags, including storing the association of the received annotation data with the markup content in the annotation database 214. That is, when the annotation data is received, the annotation manager component 210 is invoked to associate the annotation data with information identifying the bounded portion of the resource in the annotation database 214.

The information identifying the bounded portion of the resource can be embodied in a number of different ways. In one aspect, associating the received annotation data with the markup content bounded by the tag in block 106 includes associating the received annotation data with the markup content using an identifier. For example, the annotation manager component 208 can be configured for associating the received annotation data with the markup content bounded by the tag using an identifier. For example, an identifier can include a URI, or a subset of URI's, a URL, with a portion identifying the annotated portion of the resource. Alternatively, a type of the annotated entity can be used. For example, a user can annotate a password portion of a resource with a regular expression that provides a schema for passwords the user intends to use for all resources. In the current example, the identifier can be resource content, including the “term” password and a hidden string from an element for an HTML-based resource, or can be a tag of a markup language defined for receiving password information.

In either case, the annotation can be associated with resource entities that match the identifier, also referred herein to as matching data. The receipt of the annotation data and matching data by the annotation manager component 208 is depicted as a message 416 in FIG. 4. The associating of the matching data and the annotation data is depicted as messages 418 and 420.

The association between the matching data and the received annotation data can be stored in an annotation database 214, which can be provided by one or more of the client 300, as in the current example, the resource provider (discussed below), and a third-party annotation database (not shown).

FIG. 5 is a flow diagram illustrating a method for associating user-provided annotation data with markup content of a resource according to another exemplary embodiment of the subject matter described herein. FIGS. 6, 7, and 8 are block diagrams illustrating systems for associating user-provided annotation data with markup content of a resource according to other exemplary embodiments of the subject matter described herein. The method illustrated in FIG. 5 can be carried out by, for example, some or all of the components illustrated in the exemplary system of FIGS. 6, 7, and/or 8.

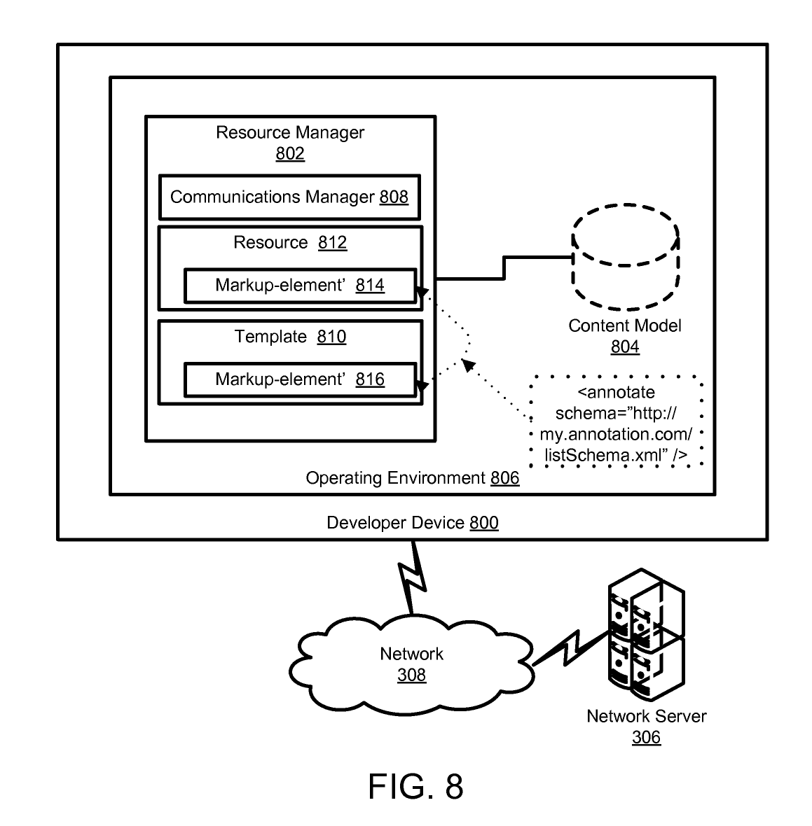

With reference to FIG. 5, in block 502 a resource including an annotation element that is defined in a markup-language for accepting annotation is provided. The annotation element is associated with a form for receiving user-provided annotation data and is associated with a tag defining a boundary of markup content for the resource. Accordingly, a system for associating user-provided annotation data with markup content of a resource includes means for providing a resource including an annotation element that is defined in a markup-language for accepting annotation, wherein the annotation element is associated with a form for receiving user-provided annotation data and is associated with a tag defining a boundary of markup content for the resource. For example, as illustrated in FIGS. 6 and 7, a resource manager component 606 is configured for providing a resource including an annotation element that is defined in a markup-language for accepting annotation to the client 300. In another example illustrated in FIG. 8 (discussed further below), a resource manager component 802 of a developer device 800 is configured for providing a resource that includes an annotation element that is defined in a markup-language for accepting annotation to the network server 306.

FIG. 6 includes the network server 306, which hosts an operating environment 604 configured to allow the operation of the resource manager component 606 and an annotation service component 608. An exemplary operating environment 604 includes (not shown): a processor, processor memory, hardware components such a NIC, a storage adapter, and persistent storage device, various software subsystems including an I/O subsystem supporting a file system and/or a database a communication subsystem including a network stack, and an operating system or control program for hosting the resource manager component 606 and the annotation service component 608 and for providing interoperability for the components.

The resource manager component 606 is configured to provide a resource that includes an annotation element, such as the <annotate> tag and/or the annotate attribute, defined in the markup language for accepting annotation. The annotation element corresponds to a form and/or input schema specifying rules for receiving annotation data. The annotation data received via the form conforming to the rules is associated with a tag defining a bounded portion of the content for the resource.

The annotation element in the provided resource can be stored in a database 704. The database 704 in the current example stores static resources, such as resource 706, which can be pre-generated. Database 704 can also include one or more templates 708. Templates 708 and static resources 706 include markup and typically contain content for processing by a client. For example, a client can display a requested markup-based resource, such as an HTML-based Web page. Templates include portions that are generated dynamically, typically just prior to sending the resource based on the template 708 to a client. Dynamically generated portions in a template 708 can be identified using server-side variable indicators included in the template for replacing with a corresponding values and/or can include server-side code, such as Java server pages allow. When a provided resource is generated using the template 708, the controller 702 can provide an identifier of the resource to a template filler 710. The template filler 710 invokes a template manger 712 and provides the resource identifier. The template manager 712 uses the identifier to retrieve the template 708 associated with the identifier from the database 704. The template 708 is returned to the template filler 710. The template filler 710 is responsible for making data for generating the dynamic portions of the resource accessible at the time of resource generation.

In the current example, the template filler 710 passes the resource identifier to a data model component 714. The data model component 714 uses the resource identifier to determine data stored in an application database 716 to retrieve for use in generating the resource based on the template 708. In addition to, or instead of retrieving stored data, the data model component 714 can communicate with other services that generate or otherwise provide data and/or the data model component 714 can generate data based on information included in a request or a command to send the requested resource. Whatever the case, data used for generating the resource is provided to the template filler 710 by the data model component 714. The template filler 710 can use the data to fill in variables detected in the template 708 and/or the template filler 710 can process server-side code included the template 708. The server-side code, when executed, accesses the data provided by the data model component 714 to the template filler 710. The server-side code generates, using the provided data, a dynamic portion of the resource based on the template 708, the provided data, and the instructions of the server-side code in the template.

In both the static resource 706 and resources generated based on the template 708, an annotation element depicted as a markup element 722, 724 is included that is associated with a tag defining a bounded portion of the resource. The bounded portion can include presentable content and/or additional markup elements. As described above, the annotation element can include an annotation tag associated with the tag defining the boundary of the markup content for the resource, where the annotation tag is defined in the markup-language for accepting annotation. Alternatively, or additionally, the annotation element includes an attribute for the tag and/or a value for a tag defining the boundary of the markup content for the resource, where the attribute and/or the attribute value is defined in the markup-language for accepting annotation.

According to another aspect, with reference to FIG. 8, the developer device 800 includes a resource manager component 802 configured for providing the resource including the annotation element that is defined in a markup-language for accepting annotation. Again here, the annotation element is associated with a form for receiving user-provided annotation data and is associated with a tag defining a boundary of markup content for the resource. The resource manager component 802 is operable within an operating environment 806 of the developer device 800. The resource manager component 802 can be configured for providing a resource by generating the resource and forwarding the resource to a content distributor or resource provider via a network, such as the server 306. For example, the resource manager component 802 can be a resource editor for generating resources having markup elements. Resource editors are well-known in the art. Examples include MICROSOFT CORPORATION's FRONTPAGE and ADOBE CORPORATION's DREAMWEAVER. According to this aspect, the resource manager component 802 can use a markup language whose schema has been extended to include an annotation element.

As the resource manager component 802 constructs a resource, a model of the resource including its content, if any, is managed by a content model 804, such as a DOM, as previously discussed. The resource manager component 802 and the content model 804 operate within the operating environment 806 provided by the developer device 800. The operating environment 806 includes, for example, a processor, processor memory, secondary storage, and an input/output system supporting devices such as a display, a keyboard, a mouse, and a disk driver. A communication manager component 808 provides for a generated resource to be transmitted to a device, such as the network server 306 via the network 308 for use in a network application such as the resource manager component 606.

As the resource manager component 802 receives input associated with the resource, commands are issued to the content model 804. The content model, in one aspect, uses a specified schema to validate any updates, additions, and deletions made to the resource. The schema is used by other applications to parse and present the resource. In the example shown, a template 810 compatible with the markup language in use that can include a markup element 814, such as an annotation element, can be used in the editor to simplify the creation of the resource. Additionally, a pre-generated resource 812 may be used in the editor as well, where the pre-generated resource 812 can include a markup element 816, such as an annotation element, that is compatible with the schema of the resource being generated.

The content model 804 stores the generated resource in a format compatible with the schema in secondary storage (not shown) or provides the formatted resource including markup language elements to the resource manager component 802.

Returning to FIG. 5, in block 504 the resource is provided to a network entity, which is one of a client and a server for providing the resource to the client. The provided resource allows for the user-provided annotation data received via the associated form to be associated with the markup content bounded by the tag via the network entity. Accordingly, a system for associating user-provided annotation data with markup content of a resource includes means for providing the resource to a network entity, wherein the network entity is one of a client and a server for providing the resource to the client, the provided resource allowing for the user-provided annotation data received via the associated form to be associated with the markup content bounded by the tag via the network entity. For example, as illustrated in FIGS. 6 and 7, the resource manager component 606 is configured for providing the resource to the client 300. In another example illustrated in FIG. 8, the resource manager component 802 of the developer device 800 is configured for providing the resource to the server 306 or to another network entity.

With reference to FIGS. 6 and 7, the server 306 can provide the resource including the annotation element to the client 300 in response to a request, such as an HTTP GET command or a remote procedure call, as illustrated in messages 404 and 406 in FIG. 4. Alternatively, the server can provide the resource asynchronously as a notification not requested by the recipient or a notification associated with a subscription of the recipient. Asynchronous delivery can be performed using protocols such, as publish/subscribe, presence protocol, extensible messaging and presence protocol (XMPP), session initiation protocol for instant messaging and presence leveraging extensions (SIP SIMPLE), e-mail, and multimedia messaging service (MMS).

In FIG. 4, the messages exchanged among the client 300, the resource manager component 606, and the annotation service component 608 are illustrated. The requests for the resource from the client 300 is handled by the resource manager component 606, as depicted by messages 404 and 406. Messages 410, 412, 416, 418, and 420 are handled at the network server 306 by the annotation service component 608, as will be discussed further below.

With reference also to FIG. 7, a request is received by the operating environment 604 of the network server 306. Typically, the request is received from the network via a NIC, passed to a network stack for routing to an identified recipient, which in this case is the resource manager component 606. The request is received by a communications manager 701 of the resource manager and forwarded for processing by a controller 702 of the resource manager component 606. The controller 702 processes the request and determines the resource requested. When a static resource, such as the resource 706 is to be provided, for example to client 300 in response to the request message 404, the controller 702 retrieves the resource 706 and sends it to the requesting client 300 in a response message depicted as a response message 406 in FIG. 4.

In another aspect, user-provided annotation data provided via the associated form is received from the client and the received annotation data is associated with the markup content bounded by the tag. For example, as illustrated in FIGS. 6 and 7, the annotation service component 608 is configured for receiving from the client user-provided annotation data provided via the associated form and for associating the received annotation data with the markup content bounded by the tag.

As described above, receiving from the client user-provided annotation data provided via the associated form can include providing a form to the client for receiving the user-provided annotation data. For example, the annotation service component 608 can be configured for providing a form to the client for receiving the user-provided annotation data. The form provided can be configured for receiving the user-provided annotation data according to a schema selected based on at least one of a provider of the resource, a type of the resource, the annotation element, the markup content bounded by the tag, other content in the resource, a task being performed via the resource, a user profile, and a time-based value. The form provided can be configured for receiving the user-provided annotation data according to a schema that is user-editable. In any case, the schema defines formatting and a rule for the user-provided annotation data. The form provided can also have one or more keywords and allow for a user to provide a value for the one or more keywords.

As described above, the received annotation data can be associated with the markup content bounded by the tag using an identifier, such as a URL. For example, the annotation service component 608 can be configured for associating the received annotation data with the markup content bounded by the tag by associating the received annotation data with the markup content using an identifier. The association can be stored in the annotation database 614 shown in FIGS. 6 and 7, as discussed above.

According to another aspect, with reference to FIG. 8, the resource manager component 802 of the developer device 800 is configured for providing the resource to a network entity by forwarding the resource to a resource provider for distribution via a network. For example, the resource manager component 802 includes the communication manager component 808, which provides a generated resource to be transmitted to a network entity, such as the network server 306 via the network 308, for use in a network application, such as the resource manager component 606. The providing of the resource to the resource manager 606 of network server 306 is illustrated by message 402 in FIG. 4.

As additional enhancements to the subject matter described, access control information may be specified or referenced for informing the browser 302 what rights the current user has (e.g., read only, read/write, write only, modify, delete, etc). Additionally, for presenting annotation data, various style attributes can be supported and may accompany the schema. For example, a cascading style sheet (CSS) or an analog can be associated with the schema using an element of the markup language defined for this purpose. Further, the annotation data may be stored in a searchable data store and used for searching for web resources or the annotation data may be used as part of the processing of a search query, such as a Web search query, for improving the returned results and/or for ranking the returned results.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for associating user-provided annotation data with markup content of a resource, the method comprising:
detecting, through processing a resource for presentation by a client, an annotation element that is defined in a markup-language for accepting annotation and that is associated with a tag defining a boundary of markup content for the resource;
presenting, based on the annotation element, a form for receiving user-provided annotation data; and
associating the received annotation data with the markup content bounded by the tag.

2. The method of claim 1 wherein the annotation element includes an annotation tag associated with the tag defining the boundary of the markup content for the resource, wherein the annotation tag is defined in the markup-language for accepting annotation.

3. The method of claim 1 wherein the annotation element includes an attribute for the tag defining the boundary of the markup content for the resource, wherein the attribute is defined in the markup-language for accepting annotation.

4. The method of claim 1 wherein detecting an annotation element includes detecting the annotation element through processing a markup-language-based page for presentation in a browser.

5. The method of claim 1 wherein detecting an annotation element includes detecting the annotation element through processing a streaming media resource including markup defined in the markup language.

6. The method of claim 1 wherein presenting a form for receiving user-provided annotation data includes presenting a form generated by the client.

7. The method of claim 1 wherein presenting a form for receiving user-provided annotation data includes presenting a form received by the client from a remote network entity.

8. The method of claim 1 wherein presenting a form for receiving user-provided annotation data includes presenting a form configured for receiving the user-provided annotation data according to a schema that defines formatting and a rule for the user-provided annotation data.

9. The method of claim 1 wherein presenting a form for receiving user-provided annotation data includes presenting a keyword and allowing for a user to provide a value for the presented keyword.

10. The method of claim 1 wherein presenting a form for receiving user-provided annotation data includes presenting a form configured for receiving the user-provided annotation data according to a schema selected based on at least one of a provider of the resource, a type of the resource, the annotation element, the markup content bounded by the tag, other content in the resource, a task being performed via the resource, a user profile, and a time-based value.

11. The method of claim 1 wherein associating the received annotation data with the markup content bounded by the tag includes associating the received annotation data with the markup content using an identifier.

12. The method of claim 1 wherein the wherein associating the received annotation data with the markup content bounded by the tag includes storing the association of the received annotation data with the markup content at one of the client, a provider of the resource, and another network entity.

13. A method for associating user-provided annotation data with markup content of a resource, the method comprising:
providing a resource including an annotation element that is defined in a markup-language for accepting annotation, wherein the annotation element is associated with a form for receiving user-provided annotation data and is associated with a tag defining a boundary of markup content for the resource; and
providing the resource to a network entity, wherein the network entity is one of a client and a server for providing the resource to the client, the provided resource allowing for the user-provided annotation data received via the associated form to be associated with the markup content bounded by the tag via the network entity.

14. The system of claim 13 wherein providing a resource including an annotation element includes generating the resource and forwarding the resource to a resource provider for distribution via a network.

15. The method of claim 13 wherein the annotation element includes an annotation tag associated with the tag defining the boundary of the markup content for the resource, wherein the annotation tag is defined in the markup-language for accepting annotation.

16. The method of claim 13 wherein the annotation element includes an attribute for the tag defining the boundary of the markup content for the resource, wherein the attribute is defined in the markup-language for accepting annotation.

17. The method of claim 13 wherein providing the resource to a network entity comprises:
providing the resource to the client;
receiving from the client user-provided annotation data provided via the associated form; and
associating the received annotation data with the markup content bounded by the tag.

18. The method of claim 17 wherein receiving from the client user-provided annotation data provided via the associated form includes providing a form to the client for receiving the user-provided annotation data.

19. The method of claim 18 wherein providing a form to the client includes providing a form configured for receiving the user-provided annotation data according to a schema that defines formatting and a rule for the user-provided annotation data

20. The method of claim 18 wherein providing a form to the client includes providing a form having a keyword and allowing for a user to provide a value for the keyword.

21. The method of claim 18 wherein providing a form to the client includes providing a form configured for receiving the user-provided annotation data according to a schema selected based on at least one of a provider of the resource, a type of the resource, the annotation element, the markup content bounded by the tag, other content in the resource, a task being performed via the resource, a user profile, and a time-based value.

22. The method of claim 17 wherein associating the received annotation data with the markup content bounded by the tag includes associating the received annotation data with the markup content using an identifier.

23. A system for associating user-provided annotation data with markup content of a resource, the system comprising:
means for detecting, through processing a resource for presentation by a client, an annotation element that is defined in a markup-language for accepting annotation and that is associated with a tag defining a boundary of markup content for the resource;
means for presenting, based on the annotation element, a form for receiving user-provided annotation data; and
means for associating the received annotation data with the markup content bounded by the tag.

24. A system for associating user-provided annotation data with markup content of a resource, the system comprising:
a markup detector component configured for detecting, through processing a resource for presentation by a client, an annotation element that is defined in a markup-language for accepting annotation and that is associated with a tag defining a boundary of markup content for the resource;
a presentation manager component configured for presenting, based on the annotation element, a form for receiving user-provided annotation data; and
an annotation manager component configured for associating the received annotation data with the markup content bounded by the tag.

25. The system of claim 24 wherein the annotation element includes an annotation tag associated with the tag defining the boundary of the markup content for the resource, wherein the annotation tag is defined in the markup-language for accepting annotation.

26. The system of claim 24 wherein the annotation element includes an attribute for the tag defining the boundary of the markup content for the resource, wherein the attribute is defined in the markup-language for accepting annotation.

27. The system of claim 24 wherein the markup detector component is configured for detecting an annotation element through processing a markup-language-based page for presentation in a browser.

28. The system of claim 24 wherein the markup detector component is configured for detecting an annotation element through processing a streaming media resource including markup defined in the markup language.

29. The system of claim 24 wherein the presentation manager component is configured for presenting a form generated by the client for receiving user-provided annotation data.

30. The system of claim 24 wherein the presentation manager component is configured for presenting a form received by the client from a remote network entity for receiving user-provided annotation data.

31. The system of claim 24 wherein the presentation manager component is configured for presenting a form configured for receiving the user-provided annotation data according to a schema that defines formatting and a rule for the user-provided annotation data.

32. The system of claim 24 wherein the presentation manager component is configured for presenting a form that presents a keyword and the form allows for a user to provide a value for the presented keyword.

33. The system of claim 24 wherein the presentation manager component is configured for presenting a form configured for receiving the user-provided annotation data according to a schema selected based on at least one of a provider of the resource, a type of the resource, the annotation element, the markup content bounded by the tag, other content in the resource, a task being performed via the resource, a user profile, and a time-based value.

34. The system of claim 24 wherein the annotation manager component is configured for associating the received annotation data with the markup content bounded by the tag using an identifier.

35. The system of claim 24 wherein the annotation manager component is configured for associating the received annotation data with the markup content bounded by the tag, including storing the association of the received annotation data with the markup content at one of the client, a provider of the resource, and another network entity.

36. A system for associating user-provided annotation data with markup content of a resource, the system comprising:
means for providing a resource including an annotation element that is defined in a markup-language for accepting annotation, wherein the annotation element is associated with a form for receiving user-provided annotation data and is associated with a tag defining a boundary of markup content for the resource; and
means for providing the resource to a network entity, wherein the network entity is one of a client and a server for providing the resource to the client, the provided resource allowing for the user-provided annotation data received via the associated form to be associated with the markup content bounded by the tag via the network entity.

37. A system for associating user-provided annotation data with markup content of a resource, the system comprising:
a resource manager component configured for:
providing a resource including an annotation element that is defined in a markup-language for accepting annotation, wherein the annotation element is associated with a form for receiving user-provided annotation data and is associated with a tag defining a boundary of markup content for the resource; and
providing the resource to a network entity, wherein the network entity is one of a client and a server for providing the resource to the client, the provided resource allowing for the user-provided annotation data received via the associated form to be associated with the markup content bounded by the tag via the network entity.

38. The system of claim 37 wherein the resource manager component is configured for generating the resource and forwarding the resource to a resource provider for distribution via a network.

39. The system of claim 37 wherein the annotation element includes an annotation tag associated with the tag defining the boundary of the markup content for the resource, wherein the annotation tag is defined in the markup-language for accepting annotation.

40. The system of claim 37 wherein the annotation element includes an attribute for the tag defining the boundary of the markup content for the resource, wherein the attribute is defined in the markup-language for accepting annotation.

41. The system of claim 37 wherein the resource manager component is configured to provide the resource to the client and the system comprises:
an annotation service component configured for:
receiving from the client user-provided annotation data provided via the associated form; and
associating the received annotation data with the markup content bounded by the tag.

42. The system of claim 41 wherein the annotation service component is configured for providing a form to the client for receiving the user-provided annotation data.

43. The system of claim 41 wherein the annotation service component is configured for providing a form configured for receiving the user-provided annotation data according to a schema that defines formatting and a rule for the user-provided annotation data

44. The system of claim 41 wherein the annotation service component is configured for providing a form to the client configured for having a keyword and allowing for a user to provide a value for the keyword.

45. The system of claim 41 wherein the annotation service component is configured for providing a form to the client configured for receiving the user-provided annotation data according to a schema selected based on at least one of a provider of the resource, a type of the resource, the annotation element, the markup content bounded by the tag, other content in the resource, a task being performed via the resource, a user profile, and a time-based value.

46. The system of claim 41 wherein the annotation service component is configured for associating the received annotation data with the markup content bounded by the tag by associating the received annotation data with the markup content using an identifier.

47. A computer readable medium including a computer program, executable by a machine, for associating user-provided annotation data with markup content of a resource, the computer program comprising executable instructions for:
detecting, through processing a resource for presentation by a client, an annotation element that is defined in a markup-language for accepting annotation and that is associated with a tag defining a boundary of markup content for the resource;
presenting, based on the annotation element, a form for receiving user-provided annotation data; and
associating the received annotation data with the markup content bounded by the tag.

48. A computer readable medium including a computer program, executable by a machine, for associating user-provided annotation data with markup content of a resource, the computer program comprising executable instructions for:
providing a resource including an annotation element that is defined in a markup-language for accepting annotation, wherein the annotation element is associated with a form for receiving user-provided annotation data and is associated with a tag defining a boundary of markup content for the resource; and
providing the resource to a network entity, wherein the network entity is one of a client and a server for providing the resource to the client, the provided resource allowing for the user-provided annotation data received via the associated form to be associated with the markup content bounded by the tag via the network entity.

49. The computer readable medium of claim 48 comprising executable instructions for:
receiving from the client user-provided annotation data provided via the associated form; and
associating the received annotation data with the markup content bounded by the tag.
